(19) United States
(12) Patent Application Publication
(10) Pub. No.: US 2004/0226416 A1
(43) Pub. Date: Nov. 18, 2004

(54) Extractor tool for removing a threaded and method of extracting

(76) Inventor: Ben Lane, King, NC (US)

Correspondence Address: CHARLES Y. LACKEY, ATTORNEY AT LAW, P.O. BOX 5871, WINSTON -SALEM, NC, 27113-5871, US

(21) Appl. No.: 10/434,634

(22) Filed: May 12, 2003

(51) Int. Cl. B25B 13/56

(52) U.S. Cl. 81/176.15

(57) ABSTRACT

A protective mounting mechanism for a motor and propeller mechanism is secured to the lower end of an elongated motor shaft and a motor support and positioning bracket supports and positions the shaft. The mounting mechanism has a clamp secured to the motor shaft and a rotor, an element of which forms a part of the clamp. The rotor has stator connecting elements and a stator has rotor connecting elements which cooperatively receive the rotor connecting elements to fix the rotor and stator in a locked condition. A spring holding member supports a spring in a biased condition to hold cooperatively engaging connecting elements within the recesses and maintain the shaft in a vertical position so that the motor and propeller mechanism are positioned in the water in a force exerting condition. A release lever is connected to the stator and is operably movable to overcome the bias of the spring, disconnect the cooperatively engaging connecting elements and separate the rotor from the stator. The spring bias is also overcome when the propeller mechanism strikes an object in the water and the motor shaft and carried motor and propeller mechanism are pivotally displaced from the water.

### BACKGROUND OF THE INVENTION

1. Field of the Invention

This invention relates to an extractor means and method for the removal or extraction of a threaded member such as a tap or bolt which been broken off in a threaded hole in a workpiece.

2. Description of Prior Art

Considerable difficulty is presented when a threaded member is broken, whether by deterioration such as rust or by the application of too much tightening torque. The extraction or removal of the embedded thre3aded member portion becomes particularly difficult when, as often occurs, the member has broken below the surface and the exposed face of the embedded portion is somewhat below the surface of the workpiece.

Conventionally, removal of the broken threaded member requires that a hole be drilled into the member. After the drill bit is removed, an “easy out” extractor is used for removal. Such extractors are formed with gripping teeth and/or shaped flutes adapted to engage the sides of a drilled bore in the broken threaded member. The gripping surfaces remove the threaded member when the extractor is rotated in a direction opposite to that of the threaded member.

Variations of this form of threaded member removal include utilizing a broken member extractor in the form of an elongate tool with an offset defining a key insertable in a corresponding hole provided in the broken threaded member, a tool having three centering points on one end which when struck against the end of a broken threaded member provides three indents for drilling holes into the shank for receiving the three pointed tool, a tool for removing a broken sparkplug from an engine cylinder, the tool having an offset for insertion into a hole with an offset drilled into the broken spark plug to back the plug out of the cylinder head of the engine, a device for removing a pipe wherein an elongate threaded member having a tapered end and a pair of diametrically opposed longitudinal slots is inserted into the pipe and a pair of tapered wedges are tapped into the slots to engage the inner surface of the pipe so that the pipe may be backed out, and a tool for extracting a broken drill or the like including finger members which are forced down into the flutes of the broken drill inside the hole so that the broken drill may be grasped and removed.

Each of the prior art devices just described suffer from one or more shortcomings seriously impairing the utility of the devices to be used for their intended purpose. In the prior art devices and methods, the end of the broken bolt shank to be removed must be accessible for drilling a hole for inserting the extractor tool. In most of the cases, the extractor tool is driven into the drilled hole with sufficient force to engage the wall thereof. Many of the prior art tools have a very short axial extent of engagement with the wall of the drilled hole, and axial alignment of the tool with the drilled hole may therefore be difficult to control with desired precision. The operation of driving the tool into the drilled hole frequently results in deformation of the threads of the tapped hole, in radially outward deformation of the drill bolt shank against the threads of the tapped hole, in radiant outward deformation of the drilled bolt shank against the threads of the tapped hole and in consequent increasing difficulty in backing the broken shaft out.

### OBJECTIVES AND SUMMARY OF THE INVENTION

It is a principal objective of the present to provide and improved extractor for broken taps which are retained within a bore and a workpiece.

Another objective of the present invention is to provide novel structure for the removal of a broken threaded member from a cylinder block or the like in total absence of any damaging effect on the female threads in the block.

A further objective of the present invention is to provide novel structure by the use of which broken threaded members may be easily removed regardless of their degree of tightness in the block and in the absence of any damage to the block threads.

Still another further objective of the present invention is to provide a tool for removing a broken threaded member from a blind or otherwise substantially inaccessible location.

Yet still another further objective of the present invention is to provide an improved method for removing broken threaded members from mating tapped holes.

The invention is a tool for extracting a threaded member from a tapped hole in a workpiece utilizing a segment of threaded rod having a forward end, a rearward end, and a diameter and threads defined thereon that correspond to the threaded member and tapped hole. A plurality of projecting fingers are carried by the segment forward end, and segment rearward end is adapted to receive a torque applying tool so that the threaded rod segment can be rotated to extract the broken threaded member from the workpiece. The segment forward end is substantially fully threaded around the axis of the segment forward end, and the threaded member has threads formed to define alternately a plurality of flutes and partial threads. When the tool is applied to the shank of the broken threaded member, the projecting fingers are cooperatively received by the defined flutes so that when torque is applied to the threaded segment, it retracts and moves the joined broken threaded member from the work piece.

The invention also includes a method for extracting from a tap tool and a workpiece a threaded member having a defined surface of alternating flutes and partial threads and having diameter and threads corresponding to that of the threaded member and tapped hole. The method includes providing a segment of threaded rod having diameter and threads defined thereafter corresponding to that of the threaded member and tapped hole. In this step the projecting fingers are cooperatively received by the flutes on the threaded member surface and torque is applied to the segment to threadably remove the threaded member from the tapped hole.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a perspective view of the threaded rod showing the flutes and partial threads;

FIG. 2 is a plan view of the threaded rod shown in FIG. 1;

FIG. 3 is a side elevational view of the rod shown in FIG. 1;

FIG. 4 is another other side view of the threaded rod shown in FIG. 1;

FIG. 5 is an end elevational view of the rod shown in FIG. 1;

FIG. 6 is a perspective view of the rod shown in FIG. 1 without the flutes and broken threads;

FIG. 7 is another embodiment of the tool comprising the present invention;

FIG. 8 is a top plan view of alternative embodiment shown in FIG. 7;

FIG. 9 is a top plan view of embodiment shown in FIG. 7;

FIG. 10 is a side elevational view of the embodiment shown in FIG. 7;

FIG. 11 is a rearward end elevational view of the tool shown in FIG. 7;

FIG. 12 is a rear elevational view of the tool shown in FIG. 7;

FIG. 13 is a side elevational schematic view of the tool engaging a broken threaded member the surface of which is below the workpiece;

FIG. 14 is a side elevational schematic view similar to that of 13 wherein the threaded member is not so far below the surface of the workpiece; and

FIG. 15 is a side elevational schematic view of extracting tool engaged with the threaded member whose shank is above the surface of the workpiece.

### DETAILED DESCRIPTION OF PREFERRED EMBODIMENT

Referring now to the drawings and particularly to FIG. 6, an extractor tool shown generally as 20 contains a segment of a threaded rod 22 having a forward end 24 and a rearward end 26. A plurality of projecting fingers 28 extend from rod forward end 24. Tool 20 is given rotary motion by the use of a wrench cooperatively received by a wrench receptacle 30. Projecting fingers 28 can be either 3 or 4 in number, and the embodiments shown in the drawings each have 3 fingers.

Tool 20 has been designed to extract a threaded member 27 that has been broken while being installed in a hole in workpiece 34. Threaded member 27 can be removed by the tool and method of the present invention even when member 26 has broken beneath the surface 40 of workpiece 34. See FIGS. 13-15.

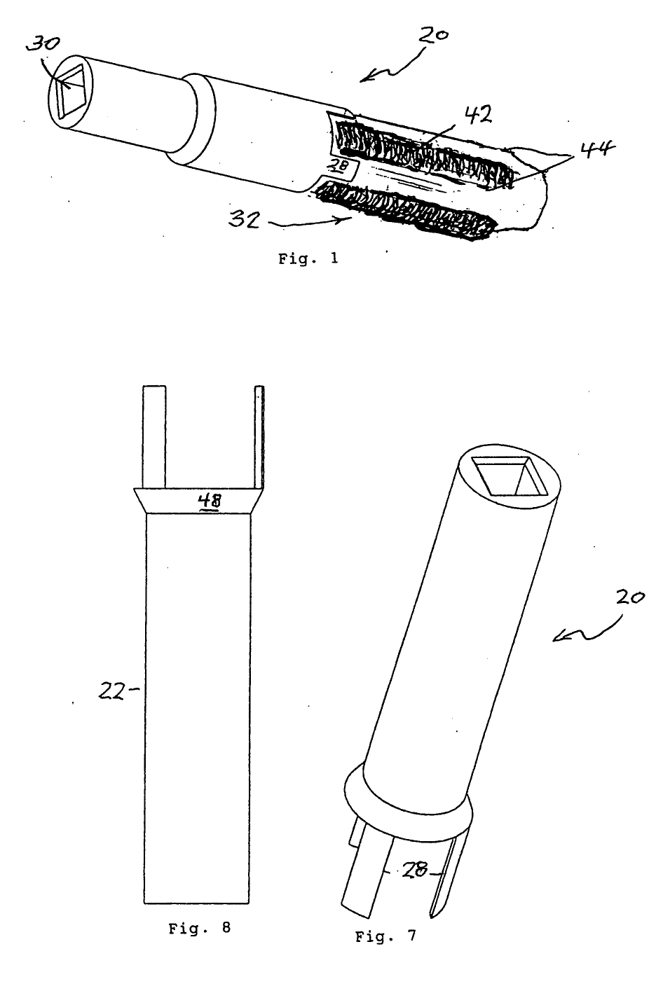

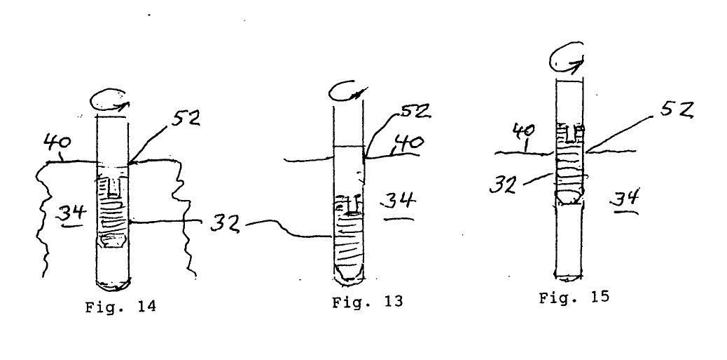

Conventional taps have a forward end with partial threads 36 rather than full threads totally encircling the forward end. The provision of alternating threads 42 and spaces (the absence of thread) as shown in FIG. 1 results in longitudinally positioned rows of partial threads 42 and flutes 44. Since flutes 44 are grooves parallel to the longitudinal axis of threaded member 26, they are suited to cooperatively receive projecting fingers 28 of selected size as shown in FIGS. 1 and 12.

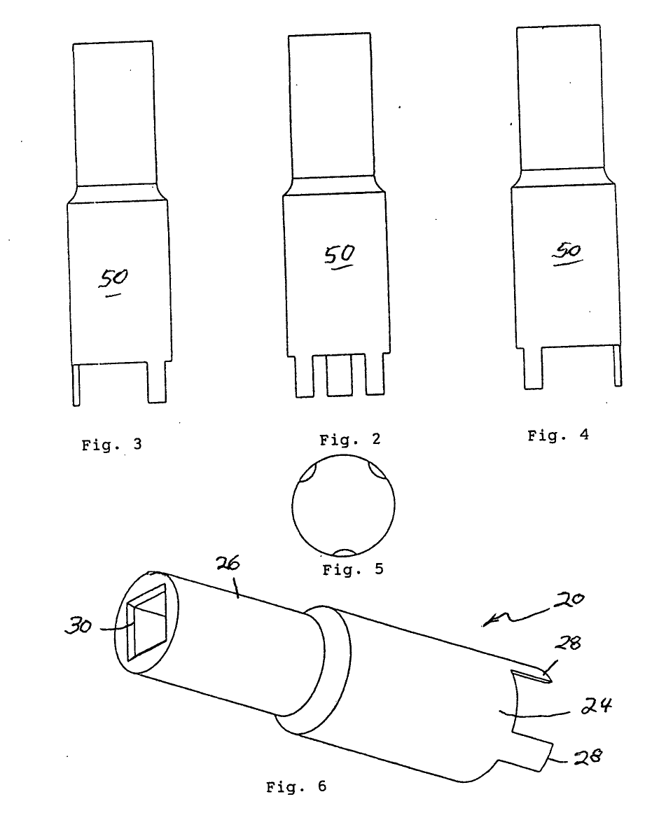

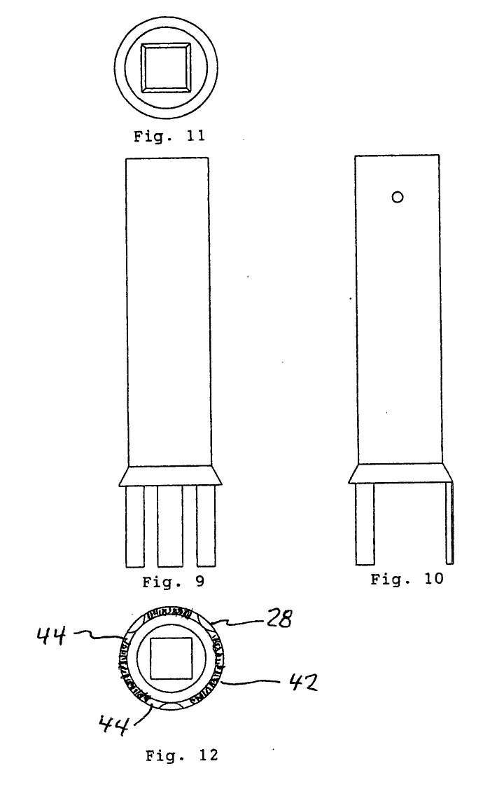

Threaded rod 22 can be an elongated member as shown in FIGS. 8-12 with projecting fingers 28 added to a diverging base 48. In some instances it is preferable to have the base portion 50 of a greater mass to provide additional strength for projecting fingers 28. See FIGS. 1 and 2-6. With fingers 28 in flutes 46, tool 20 can be rotated in a removing or extracting direction as shown in FIGS. 13-15 which movement will rotate broken threaded member 26. Tool 20 will avoid any damage to the tapped hole 52 in the workpiece 34 since all fingers reside within flutes 46 which are deep enough to protect fingers 28 from the wall of tapped hole 52. See FIG. 12.

The present invention also includes a method for extracting from a tapped hole 52 in a workpiece 34 a broken threaded member 27 having a defined surface of alternating flutes 46 and partial threads 42 and having diameter and threads corresponding to that of the threaded member 26 and tapped hole. Projecting fingers 28 of the segment are inserted in flutes 46 of broken threaded member 27 to positively join the rod segment with the threaded member. Torque is then applied to the rod segment to threadably remove the rod segment and the connected threaded member from the tapped hole.

From the preceding description, it can be seen that a carefully designed tool for extracting from a tapped hole in a workpiece a threaded member that will meet all the advantages of prior art devices and offer additional advantages not heretofore available. With respect to the foregoing invention, the optimum dimensional relationship to the parts of the invention including variations in size, materials, shape, form, function and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not intended to limit the invention to the exact construction and operation shown and described. All suitable modifications and equivalents that fall within the scope of the appended claims are deemed within the present inventive concept.

What is claimed is:

1. A tool for extracting a threaded member from a tapped hole in a workpiece comprising: a segment of threaded rod of preselected length and having a forward end, a rearward end and diameter and threads defined thereon corresponding to that of the threaded member and tapped hole; a plurality of projecting fingers carried by the segment forward end; and means defined in the segment rearward end for applying torque to the segment.

2. The tool as claimed in claim 1 wherein the means in the segment rearward end for applying torque to the segment includes a wrench receptacle.

3. The tool as claimed in claim 1 wherein the segment forward end is substantially fully threaded around the axis of the segment forward end.

4. The tool as claimed in claim 1 wherein the threaded member has threads formed to define alternately a plurality of flutes and partial threads.

5. The tool as claimed in claim 1 wherein the number of projecting fingers is 3.

6. The tool as claimed in claim 4 wherein the projecting fingers are cooperatively received by one or more of the defined flutes.

7. A tool for extracting a threaded member from a tapped hole in a workpiece comprising: a segment of threaded rod of preselected length and having a forward end, a rearward end and diameter and threads defined thereon corresponding to that of the threaded member and tapped hole; a plurality of projecting fingers carried by the segment forward end, the segment forward end having a diameter greater than the diameter of the rearward end and means defined in the segment rearward end for applying torque to the segment wherein the segment forward end is substantially fully threaded around the axis of the segment forward end, the threaded member has threads formed to define alternately a plurality of flutes and partial threads, the number of projecting fingers is 3 and the projecting fingers are cooperatively received by one or more of the defined flutes.

8. The tool as claimed in claim 7 wherein the means in the segment rearward end for applying torque to the segment includes a wrench receptacle.

9. The tool as claimed in claim 7 wherein the number of projecting fingers is 2.

10. A method for extracting from a tapped hole in a workpiece a threaded member having a defined surface of alternating flutes and partial threads and having diameter and threads corresponding to that of the threaded member and tapped hole, the segment presenting an end surface situated below the surface defining the tapped hole, the method comprising the steps of: providing a segment of threaded rod of preselective length and having diameter and threads defined thereon corresponding to that of the threaded member and the tapped hole, the rod segment having a plurality of projecting fingers extending from the rod segment forward end and cooperatively received by a plurality of flutes on the surface of the threaded member to positively join the rod segment with the threaded member; and applying torque to the rod segment to threadably remove the rod segment and the threaded member from the tapped hole.

11. The tool as claimed in claim 3 wherein the threaded member has threads formed to define alternately a plurality of flutes and partial threads.

12. The tool as claimed in claim 1 wherein the diameter of the segment forward end is larger than the diameter of the segment rearward end.

13. The tool as claimed in claim 1 wherein the torque applying means is a wrench.

14. The tool as claimed in claim 7 wherein the torque applying means is a wrench.

15. The tool as claimed in claim 4 wherein the number of projecting fingers is 4.
